(19) United States
(12) Patent Application Publication
(10) Pub. No.: US 2024/0161309 A1
(43) Pub. Date: May 16, 2024

(54) IMAGE CAPTURING APPARATUS, CONTROL METHOD OF IMAGE CAPTURING APPARATUS, AND PROGRAM RECORDING MEDIUM

(71) Applicant: CANON KABUSHIKI KAISHA, Tokyo (JP)

(72) Inventor: SHINJIRO TAKAMI, Kanagawa (JP)

(21) Appl. No.: 18/495,067

(22) Filed: Oct. 26, 2023

(30) Foreign Application Priority Data
Nov. 14, 2022 (JP) 2022-182177

(51) Int. Cl. G06T 7/20; G06V 10/25; H04N 23/61; H04N 23/63

(52) U.S. Cl. CPC G06T 7/20; G06V 10/25; H04N 23/61; H04N 23/631; G06T 2207/20104

(57) ABSTRACT

An image capturing apparatus as one aspect of the present invention images a tracking target, receives information of a first area, which is an area for tracking the tracking target, and information of a second area different from the first area, from a client apparatus, and notifies the client apparatus of information indicating whether the second area is outside a range of the first area as a first notification.

### BACKGROUND OF THE INVENTION

### Field of the Invention

The present invention relates to an image capturing apparatus, an image capturing apparatus control method, and a program recording medium.

### Description of the Related Art

In recent years, a network camera having a PTZ mechanism has been equipped with a function of starting tracking in response to a user's request and performing PTZ control to track an object detected in a captured video.

In general, after an administrator sets the size of a tracking target and an area related to a tracking operation before tracking is started, a tracking start request is made, and tracking is started. Area settings related to the tracking operation include tracking area settings of a tracking imaging area that limits an imaging range during tracking, an initial position area that moves when a tracking target is lost during tracking, and a priority display area that is imaged with preference to a tracking target during tracking. Furthermore, there are various tracking area settings for, such as a fixed angle-of-view area, which is an area where an angle of view is fixed when a tracking target is included during tracking, and a tracking target detection area for designating a human body detection area at the start of tracking.

In this manner, it is necessary to set various tracking areas, inconsistency occurs between the set tracking areas, and a tracking operation may not be performed as intended by a user. For example, when an initial position area is set outside a tracking imaging area and the tracking target is lost, a camera may move to the set initial position area and image the outside of the tracking imaging area, or may move into the tracking imaging area instead of moving to the initial position area. Thereby, an operation different from that in the tracking area set by the user may be performed and may not be a tracking operation intended by the user.

### SUMMARY OF THE INVENTION

An object of the present invention is to provide an image capturing apparatus that prevents inconsistency between set tracking areas and enables a user's intended tracking.

An image capturing apparatus as one aspect of the present invention images a tracking target, receives information of a first area, which is an area for tracking the tracking target, and information of a second area different from the first area, from a client apparatus, and notifies the client apparatus of information indicating whether the second area is outside a range of the first area as a first notification.

Further features of the present invention will become apparent from the following description of exemplary embodiments with reference to the attached drawings.

### BRIEF DESCRIPTION OF THE DRAWINGS

FIG. 1 is a network configuration diagram including configurations of a network camera and a client apparatus according to a first embodiment.

FIGS. 2A and 2B are respectively a functional block diagram and a system configuration diagram of the network camera and the client apparatus according to the first embodiment.

FIG. 3 is a sequence diagram of tracking area setting and tracking start between the client apparatus and the network camera according to the first embodiment.

FIG. 4 is a diagram illustrating a tracking execution screen of the client apparatus according to the first embodiment.

FIG. 5 is a diagram illustrating a first setting screen of the client apparatus according to the first embodiment.

FIG. 6 is a diagram illustrating a second setting screen of the client apparatus according to the first embodiment.

FIG. 7 is a diagram illustrating a third setting screen of the client apparatus according to the first embodiment.

FIG. 8 is a diagram illustrating a fourth setting screen of the client apparatus according to the first embodiment.

FIG. 9 is a diagram illustrating a fifth setting screen of the client apparatus according to the first embodiment.

FIG. 10 is a diagram illustrating a notification that an initial position area of the network camera is outside a tracking imaging area and the display of the second setting screen of the client apparatus according to the first embodiment.

FIG. 11 is a diagram illustrating a notification that a tracking area other than a tracking imaging area of the network camera is outside the tracking imaging area and the display of the first setting screen of the client apparatus according to the first embodiment.

FIG. 12 is a diagram illustrating a notification that a tracking area other than a tracking imaging area of the network camera is outside the tracking imaging area and the display of a tracking execution screen of the client apparatus according to the first embodiment.

FIG. 13 is a diagram illustrating a notification that an initial position area of a network camera is outside a tracking imaging area and the display of a second setting screen of a client apparatus according to a second embodiment.

FIG. 14 is a diagram illustrating a notification that an initial position area of a network camera is outside a tracking imaging area and the display of a second setting screen of a client apparatus according to a third embodiment.

### DESCRIPTION OF THE EMBODIMENTS

Hereinafter, embodiments will be described in detail with reference to the accompanying drawings. In addition, the following embodiments do not limit the invention according to the scope of claims. Although a plurality of features are described in the embodiments, not all of these multiple features are essential to the invention, and a plurality of features may be combined arbitrarily. Furthermore, in the accompanying drawings, the same or similar configurations are denoted by the same reference numerals, and redundant description is omitted.

### First Embodiment

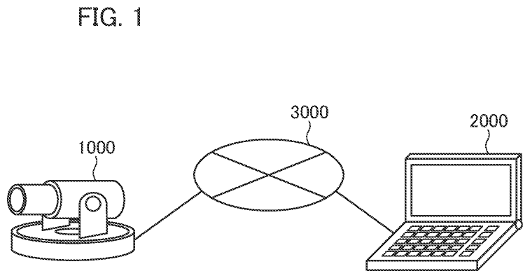

A system (imaging system) including a network camera (image capturing apparatus) 1000 and a client apparatus 2000 will be described below with reference to FIG. 1. FIG. 1 is a system configuration diagram including the network camera 1000 and the client apparatus 2000 according to the first embodiment. A system (imaging system) in the first embodiment is configured to include the network camera 1000 and the client apparatus 2000. In the system according to the first embodiment, the network camera 1000 and the client apparatus 2000 are connected via a network 3000 to be able to communicate with each other.

The client apparatus 2000 transmits a control command (control signal) for acquiring a tracking setting user interface (UI) for operating a tracking area setting to the network camera 1000. After receiving the control command, the network camera 1000 transmits the tracking setting UI to the client apparatus. Thereby, the client apparatus 2000 acquires the tracking setting UI. The client apparatus 2000 may acquire a tracking setting graphical user interface (GUI) in addition to the tracking setting UI. UI is an acronym for “user interface.” GUI is an acronym for “graphical user interface.” A GUI is a user interface that provides intuitive operations using computer graphics and a pointing device.

Further, the client apparatus 2000 acquires tracking area information including information on a tracking area and whether the tracking area falls outside a tracking imaging area and information on a tracking area such as a PTZ movable range, and transmits each tracking area setting and a control command such as the start of tracking. After receiving these control commands, the network camera 1000 transmits a response to each control command to the client apparatus 2000. The PTZ movable range is a movable range in panning driving, tilting driving, and zooming driving in the network camera 1000.

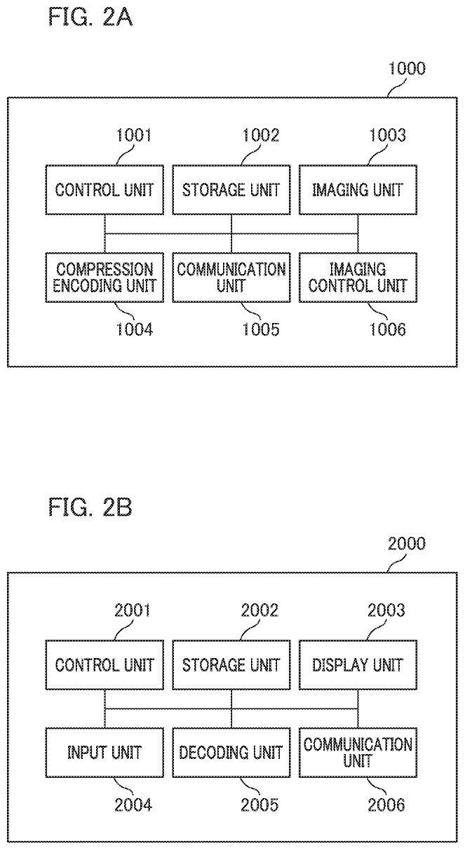

FIG. 2 is a functional block diagram and a system configuration diagram of the network camera 1000 and the client apparatus 2000 according to the first embodiment. FIG. 2A is a diagram illustrating a functional configuration of the network camera 1000. FIG. 2B is a diagram illustrating a functional configuration of the client apparatus 2000.

The network camera 1000 in the first embodiment is configured to include a control unit 1001, a storage unit 1002, an imaging unit 1003, a compression encoding unit 1004, a communication unit 1005, and an imaging control unit 1006.

The control unit 1001 includes one or more CPUs (processors) and is constituted by at least one computer. The control unit 1001 is connected to each component of the network camera 1000 via lines and executes processing in accordance with programs and data stored in the storage unit 1002 to realize the functions of the respective functional units of the compression encoding unit 1004, the imaging control unit 1006, and the communication unit 1005. The control unit 1001 comprehensively controls operation adjustment and the like of components of the entire network camera 1000.

For example, the control unit 1001 transmits information, image data, and the like stored in the storage unit 1002, which will be described later, to external equipment such as the client apparatus 2000 in response to a control command transmitted from the external equipment. The control unit 1001 transmits each notification, which will be described later, to the client apparatus 2000. The control unit 1001 performs processing for detecting a tracking target such as a person or an object shown in an image and tracking processing for associating the detected person or object between images. The control unit 1001 acquires a tracking result (tracking information) by performing person detection processing and tracking processing.

The storage unit 1002 is mainly a storage area for programs executed by the control unit 1001 and a storage area for a work area during execution of a program. The storage unit 1002 is constituted by a main storage device and an auxiliary storage device. The main storage device is a storage device such as a random access memory (RAM). The main storage device has an area for storing computer programs and data loaded from the auxiliary storage device, captured images, and various data received from the client apparatus 2000. Further, the main storage device has a work area used when the control unit 1001 executes various processing. The auxiliary storage device is a large-capacity information storage device such as a hard disk drive (HDD), a read only memory (ROM), or a solid state drive (SSD). The auxiliary storage device stores an operating system (OS), and computer programs and data for causing the control unit 1001 to execute or control each process performed by the network camera 1000. The computer programs and data stored in the auxiliary storage device are appropriately loaded into the main storage device under the control of the control unit 1001 and are processed by the control unit 1001. Further, the storage unit 1002 is not limited to the above-described areas and is used as a storage area for various data such as an area storing the tracking setting UI, a setting value storage area including tracking area information of the network camera 1000, a storage area for image data and video data generated by the imaging unit 1003, which will be described later, and the like.

The imaging unit 1003 includes an imaging lens, an imaging sensor such as a CCD or a CMOS, a signal processing unit, and the like, and images a subject to be tracked, and the like. The imaging unit 1003 converts an analog signal acquired by capturing an image of a subject which is formed by an imaging optical system of the network camera 1000 into digital data, and outputs the digital data to the storage unit 1002 as a captured image. When the captured image is output to the storage unit 1002, the control unit 1001 receives an image acquisition event from the imaging unit 1003. The compression encoding unit 1004 performs compression encoding processing on the captured image output from the imaging unit 1003 based on a format such as JPEG, H.264, or H.265 to generate image data and outputs the generated image data to the storage unit 1002.

The communication unit 1005 receives each control command and a tracking setting UI acquisition request from external equipment. The communication unit 1005 transmits a response to each control command, the tracking setting UI, image data, videos, and the like to external equipment such as the client apparatus 2000. Upon receiving the control command from the external equipment such as the client apparatus 2000, the control unit 1001 receives a command reception event from the communication unit 1005. The imaging control unit 1006 performs control such as changing an imaging range of the imaging unit 1003 to panning driving, tilting driving, or zooming driving in accordance with the value of panning, tilting, or zooming which is input by the control unit 1001.

The client apparatus (information processing device) 2000 in the first embodiment is configured to include a control unit 2001, a storage unit 2002, a display unit 2003, an input unit 2004, a decoding unit 2005, and a communication unit 2006.

The control unit 2001 includes one or more CPUs (processors), one or a plurality of memories (storage units), and the like, and is constituted by at least one computer. The control unit 2001 is connected to each component of the client apparatus 2000 via lines, and comprehensively controls operation adjustment and the like of components of the entire client apparatus 2000 in accordance with programs stored in a memory.

The storage unit 2002 is a storage area for programs mainly executed by the control unit 2001 and a storage area for various data such as a work area during execution of a program. The display unit 2003 is constituted by, for example, an LCD, an organic EL display, or the like, and displays a tracking setting UI screen or the like acquired from the network camera 1000 to a user of the client apparatus 2000. Further, the display unit 2003 may display a screen of a tracking setting GUI instead of the tracking setting UI.

The input unit 2004 is constituted by, for example, buttons, a cross key, a touch panel, a mouse, or the like, and notifies the control unit 2001 of the content of screen operations performed by the user. The decoding unit 2005 decodes compression-encoded image data received via the communication unit 2006 based on a format such as JPEG, H.264, or H.265 and loads the decoded image data to the storage unit 2002. The communication unit 2006 transmits control commands such as acquisition of a tracking setting UI, acquisition of tracking area information, setting of a tracking area, and start of tracking to the network camera 1000. The communication unit 2006 is used when receiving a response to each control command, a tracking setting UI, a video, or an image from the network camera 1000. The compression-encoded image data transmitted from the network camera 1000 is acquired via the communication unit 2006.

The functional configurations (internal configurations) of the network camera 1000 and the client apparatus 2000 have been described above with reference to FIG. 2. However, the processing blocks illustrated in FIG. 2 are examples of preferred embodiments of the network camera and the client apparatus in the first embodiment, and are not limited thereto. For example, the network camera 1000 and the client apparatus 2000 can be modified and changed in various ways within the scope of the present invention, such as including an audio input unit and an audio output unit. These processes can be realized, for example, by causing the control unit 1001 operating in the network camera 1000 to execute a corresponding program (stored in an HD or the like). Further, for example, the processes can be realized by causing the control unit 2001 operating in the client apparatus 2000 to execute a corresponding program (stored in an HD or the like).

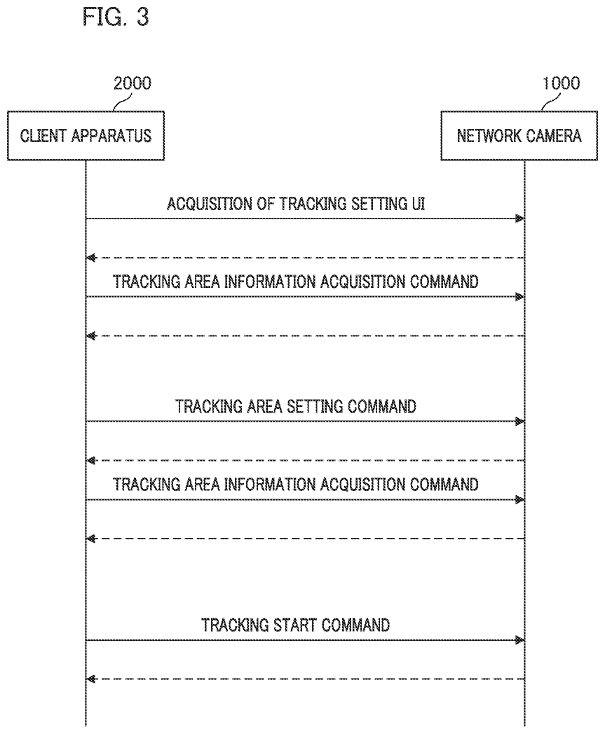

Next, with reference to FIG. 3, a sequence of tracking area setting and tracking start of the network camera 1000 and the client apparatus 2000 will be described. FIG. 3 is a sequence diagram of tracking area setting and tracking start between the client apparatus 2000 and the network camera 1000 according to the first embodiment.

The client apparatus 2000 transmits a control command (control signal) for requesting for acquisition of a tracking setting UI to the network camera 1000 via the communication unit 2006. After the communication unit 1005 receives the control command for the acquisition request, the network camera 1000 acquires the tracking setting UI from the storage unit 1002 and transmits the acquired tracking setting UI to the client apparatus 2000 via the communication unit 1005. After acquiring the tracking setting UI, the client apparatus 2000 displays the tracking setting UI on a screen of the display unit 2003.

Next, the user operates the tracking setting UI displayed on the screen of the display unit 2003, and the client apparatus 2000 transmits a tracking area information acquisition command to the network camera 1000 via the communication unit 2006. After receiving the tracking area information acquisition command via the communication unit 1005, the network camera 1000 acquires tracking area information from the storage unit 1002 and transmits the acquired tracking area information to the client apparatus 2000. The tracking setting UI updates displayed contents of the tracking setting UI based on various information such as the currently set tracking area included in the received tracking area information, information on whether a tracking area is outside a tracking imaging area, and a PTZ movable range.

Next, when the user sets a tracking area by operating the tracking setting UI displayed on the screen of the display unit 2003, the client apparatus 2000 transmits a tracking area setting command to the network camera 1000 via the communication unit 2006. When the communication unit 1005 receives the tracking area setting command, the network camera 1000 stores the tracking area setting in the storage unit 1002 with the contents of the tracking area setting command. The tracking setting UI transmits the tracking area information acquisition command to the network camera 1000, acquires tracking area information, and updates the displayed contents of the tracking setting UI with the contents of the received tracking area information.

Next, when a tracking start operation is performed using the tracking setting UI displayed on the screen of the display unit 2003, the client apparatus 2000 transmits a tracking start command to the network camera 1000 via the communication unit 2006. After the network camera 1000 receives the tracking start command via the communication unit 1005, the control unit 1001 transmits a signal to the imaging control unit 1006 based on the contents of the tracking area setting. The imaging control unit 1006 controls the imaging unit 1003 (PTZ control) based on the transmitted control signal to start tracking a tracking target.

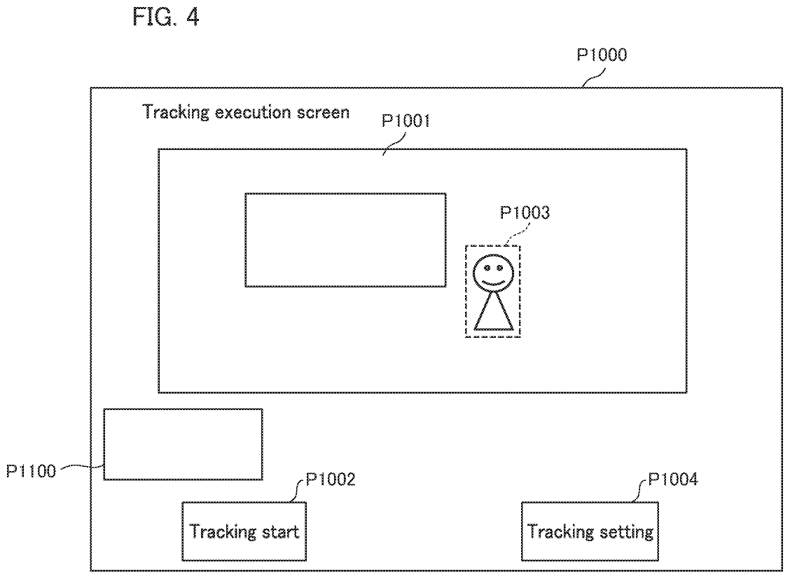

Next, a tracking execution screen P1000 will be described with reference to FIG. 4. FIG. 4 is a diagram illustrating a tracking execution screen of the client apparatus 2000 according to the first embodiment. The tracking execution screen P1000 is a screen (UI) for transitioning to a screen for executing tracking or a screen for setting tracking. The tracking execution screen P1000 is displayed on the display unit 2003 of the client apparatus 2000 so that it can be operated and set. A video display area P1001, an information display area P1100, a tracking start button P1002, a frame P1003, and a tracking setting button P1004 are displayed on the tracking execution screen P1000.

The video display area P1001 is a display area for displaying a video received from the network camera 1000. The information display area P1100 is a display area for displaying a tracking setting error or the like. It is preferable that the tracking setting error or the like displayed in the information display area P1100 be a message based on the detected error. However, this is not limiting, and a predetermined icon corresponding to the error or the like may be displayed.

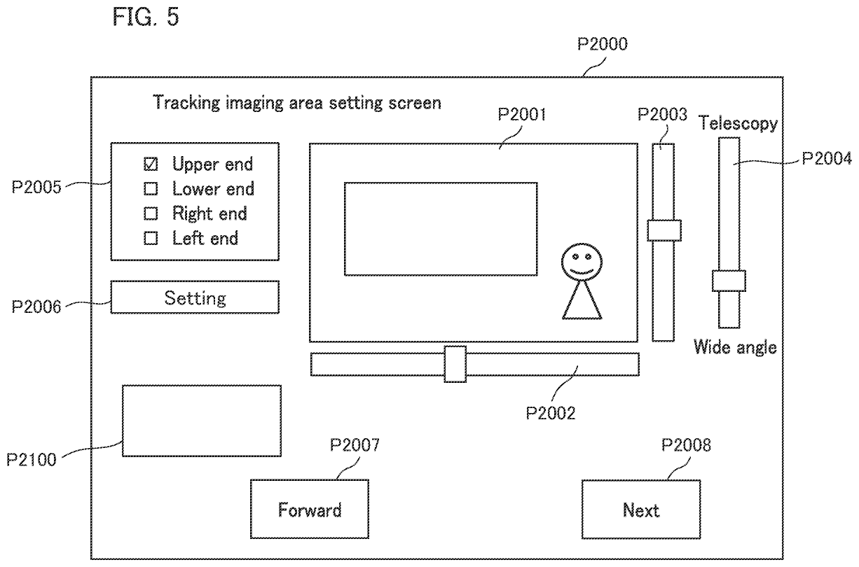

Here, when the user operates the input unit 2004 and presses the tracking start button P1002, a tracking start command is transmitted from the communication unit 2006 to the network camera 1000. When the communication unit 1005 receives the tracking start command from the client apparatus 2000, the network camera 1000 starts a tracking operation (tracking processing). During this tracking operation, the frame P1003 is displayed in the video display area P1001 as a frame surrounding a person or a tracking target so as to be superimposed on the video display area P1001. Thereby, the tracking target can be indicated to the user. Although the frame P1003 is rectangular in the drawing, it may be displayed in any shape as long as it surrounds the outline of the tracking target. On the other hand, when the input unit 2004 is operated and the tracking setting button P1004 is pressed, the screen transitions to a first setting screen P2000 illustrated in FIG. 5.

Next, the first setting screen P2000 will be described with reference to FIG. 5. FIG. 5 is a diagram illustrating the first setting screen P2000 of the client apparatus 2000 according to the first embodiment. The first setting screen P2000 is a setting screen (UI) for setting a tracking imaging area (first area).

The first setting screen P2000 is displayed on the display unit 2003 of the client apparatus 2000 so that it can be operated and set. A video display area P2001, an information display area P2100, a panning operation bar P2002, a tilting operation bar P2003, and a zooming operation bar P2004 are displayed on the first setting screen P2000. Furthermore, a check box P2005, a setting button P2006, a forward button P2007, and a next button P2008 are displayed on the first setting screen P2000.

The video display area P2001 is a display area for displaying a video received from the network camera 1000. The information display area P2100 is a display area for displaying a tracking setting error or the like. It is preferable that the tracking setting error or the like displayed in the information display area P2100 on the first setting screen P2000 be a message based on the detected error. However, this is not limiting, and a predetermined icon corresponding to the error or the like may be displayed. The check box P2005 is a check box making it possible to select which one of upper, lower, right, or left ends of the tracking imaging area is to be set.

Here, the user operates the input unit 2004 to check the check box P2005 and selects an end of the tracking imaging area to be set. Further, the user operates the panning operation bar P2002, the tilting operation bar P2003, and the zooming operation bar P2004 by using the input unit 2004 while viewing the video display area P2001, and moves the camera to the end of the tracking imaging area to be set. The panning operation bar P2002 in FIG. 5 is an operation bar that can be operated in the horizontal direction in the drawing. The tilting operation bar P2003 and the zooming operation bar P2004 are operation bars that can be operated in the vertical direction in the drawing.

When the user operates the input unit 2004 and presses the setting button P2006, a tracking area setting command including information on the tracking imaging area is transmitted from the communication unit 2006 to the network camera 1000. After the communication unit 1005 receives the tracking start command from the client apparatus 2000, the network camera 1000 stores a tracking imaging area setting in the storage unit 1002.

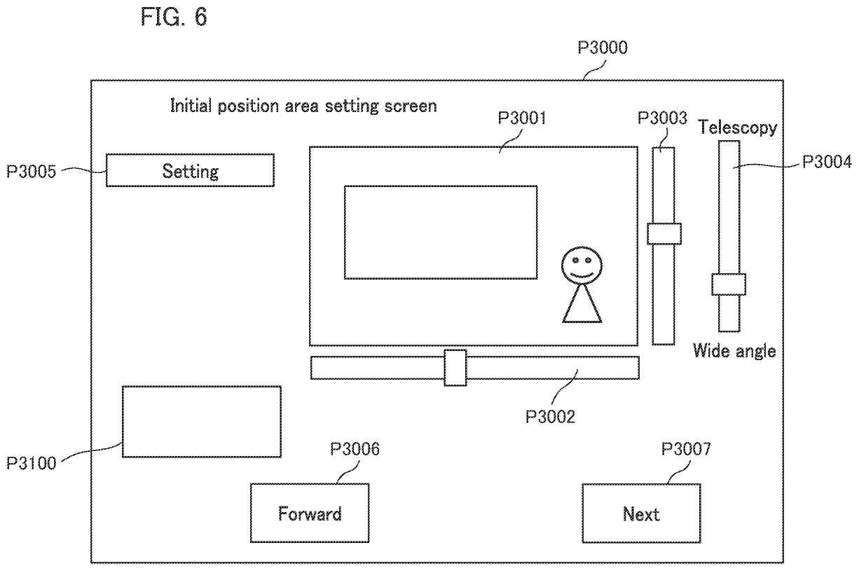

When the input unit 2004 is operated and the forward button P2007 is pressed, the screen transitions to the tracking execution screen P1000 in FIG. 4. On the other hand, when the input unit 2004 is operated and the next button P2008 is pressed, the screen transitions to a second setting screen P3000 illustrated in FIG. 6.

Next, the second setting screen P3000 will be described with reference to FIG. 6. FIG. 6 is a diagram illustrating the second setting screen P3000 of the client apparatus 2000 according to the first embodiment. The second setting screen P3000 is a setting screen (UI) for setting an initial position area (second area). The initial position area is an area to which the imaging control unit 1006 controls (PTZ control) the imaging unit 1003 to move it (return area) when as tracking target is lost during tracking. The initial position area is different from the tracking imaging area set on the setting screen illustrated in FIG. 5, but is an area related to a tracking operation (another tracking imaging area).

The second setting screen P3000 is displayed on the display unit 2003 of the client apparatus 2000 so that it can be operated and set. A video display area P3001, an information display area P3100, a panning operation bar P3002, a tilting operation bar P3003, and a zooming operation bar P3004 are displayed on the second setting screen P3000. Further, a setting button P3005, a forward button P3006, and a next button P3007 are displayed on the second setting screen P3000.

The video display area P3001 is a display area for displaying a video received from the network camera 1000. The information display area P3100 is a display area for displaying a tracking setting error or the like. It is preferable that the tracking setting error or the like to be displayed in the information display area P3100 on the second setting screen P3000 be a message based on the detected error. However, this is not limiting, and a predetermined icon corresponding to the error or the like may be displayed.

Here, the user operates the panning operation bar P3002, the tilting operation bar P3003, and the zooming operation bar P3004 by using the input unit 2004 while viewing the video display area P3001 and moves the camera to an end of the initial position area to be set. The panning operation bar P3002 in FIG. 6 is an operation bar that can be operated in the horizontal direction in the drawing. The tilting operation bar P3003 and the zooming operation bar P3004 are operation bars that can be operated in the vertical direction in the drawing.

When the user operates the input unit 2004 and presses the setting button P3005, a tracking area setting command including information on the initial position area is transmitted from the communication unit 2006 to the network camera 1000. After the communication unit 1005 receives the tracking area setting command from the client apparatus 2000, the network camera 1000 stores an initial position area setting in the storage unit 1002.

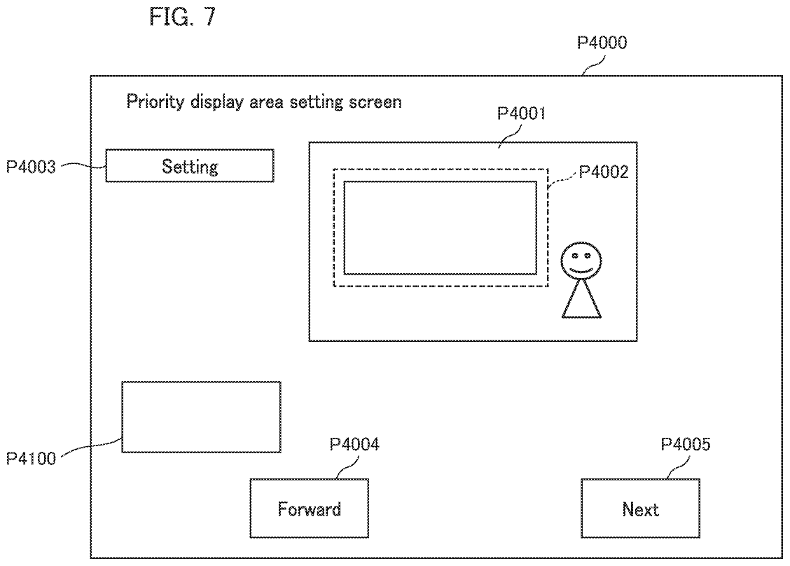

When the input unit 2004 is operated and the forward button P3006 is pressed, the screen transitions to the first setting screen P2000 in FIG. 5. On the other hand, when the input unit 2004 is operated and the next button P3007 is pressed, the screen transitions to a third setting screen P4000 illustrated in FIG. 7.

Next, the third setting screen P4000 will be described with reference to FIG. 7. FIG. 7 is a diagram illustrating the third setting screen P4000 of the client apparatus 2000 according to the first embodiment. The third setting screen P4000 is a setting screen (UI) for setting a priority display area (second area). The priority display area is an area that is imaged in preference to a tracking target during tracking. The priority display area is different from the tracking imaging area that is set on the setting screen illustrated in FIG. 5, but is an area related to a tracking operation (another tracking imaging area).

The third setting screen P4000 is displayed on the display unit 2003 of the client apparatus 2000 so that it can be operated and set. A video display area P4001, an information display area P4100, a priority display area frame P4002, a setting button P4003, a forward button P4004, and a next button P4005 are displayed on the third setting screen P4000.

The video display area P4001 is a display area for displaying a video received from the network camera 1000. The information display area P4100 is a display area for displaying a tracking setting error or the like. It is preferable that the tracking setting error or the like displayed in the information display area P4100 on the third setting screen P4000 be a message based on the detected error. However, this is not limiting, and a predetermined icon corresponding to the error or the like may be displayed.

Here, the user operates the input unit 2004 to designate the priority display area frame P4002 on the video display area P4001. The priority display area frame P4002 illustrated in FIG. 7 is an example, and the user can designate a frame having any size. Next, when the user operates the input unit 2004 and presses the setting button P4003, a tracking area setting command including information on the priority display area is transmitted from the communication unit 2006 to the network camera 1000. After the communication unit 1005 receives the tracking area setting command from the client apparatus 2000, the network camera 1000 stores a priority display area setting in the storage unit 1002.

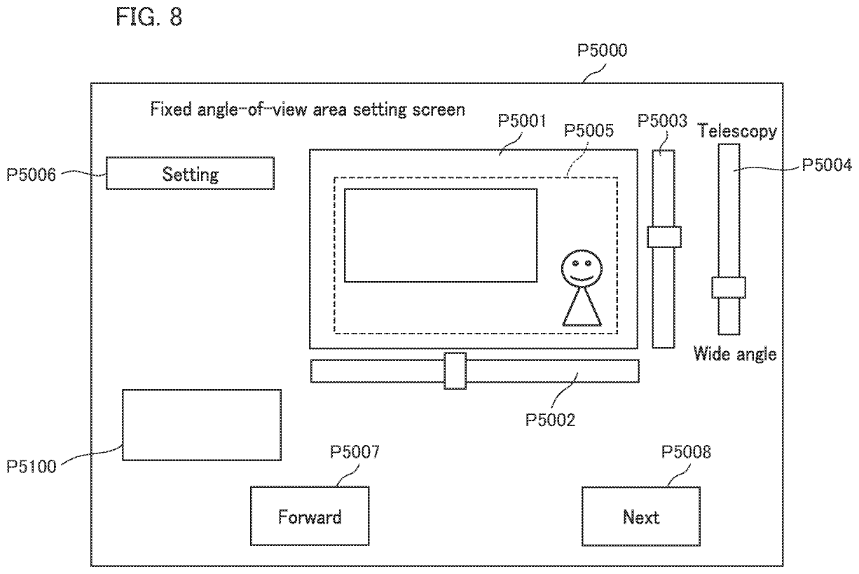

When the input unit 2004 is operated and the forward button P4004 is pressed, the screen transitions to the second setting screen P3000 illustrated in FIG. 6. On the other hand, when the input unit 2004 is operated and the next button P4005 is pressed, the screen transitions to a fourth setting screen P5000 illustrated in FIG. 8.

Next, the fourth setting screen P5000 will be described with reference to FIG. 8. FIG. 8 is a diagram illustrating the fourth setting screen P5000 of the client apparatus 2000 according to the first embodiment. The fourth setting screen P5000 is a setting screen (UI) for setting a fixed angle-of-view area (second area). The fixed angle-of-view area is an area that is used as an imaging area when a tracking target enters the set fixed angle-of-view area. The fixed angle-of-view area is different from the tracking imaging area that is set on the setting screen illustrated in FIG. 5, but is an area related to a tracking operation (another tracking imaging area).

The fourth setting screen P5000 is displayed on the display unit 2003 of the client apparatus 2000 so that it can be operated and set. A video display area P5001, an information display area P5100, a panning operation bar P5002, a tilting operation bar P5003, a zooming operation bar P5004, and a fixed angle-of-view area frame P5005 are displayed on the fourth setting screen P5000. Furthermore, a setting button P5006, a forward button P5007, and a next button P5008 are displayed on the fourth setting screen P5000.

The video display area P5001 is a display area for displaying a video received from the network camera 1000. The information display area P5100 on the fourth setting screen P5000 is a display area for displaying a tracking setting error or the like. It is preferable that the tracking setting error or the like displayed in the information display area P5100 be a message based on the detected error. However, this is not limiting, and a predetermined icon corresponding to the error or the like may be displayed.

Here, the user operates the panning operation bar P5002, the tilting operation bar P5003, and the zooming operation bar P5004 by using the input unit 2004 while viewing the video display area P5001, and moves the camera to an imaging area including a fixed angle-of-view area to be set. The panning operation bar P5002 in FIG. 8 is an operation bar that can be operated in the horizontal direction in the drawing. The tilting operation bar P5003 and the zooming operation bar P5004 are operation bars that can be operated in the vertical direction in the drawing.

The user operates the input unit 2004 to designate the fixed angle-of-view area frame P5005 on the video display area P5001. The fixed angle-of-view area frame P5005 illustrated in FIG. 8 is an example, and the user can designate a frame having any size. Next, when the user operates the input unit 2004 and presses the setting button P5006, a tracking area setting command including information on the fixed angle-of-view area is transmitted from the communication unit 2006 to the network camera 1000. After the communication unit 1005 receives the tracking area setting command from the client apparatus 2000, the network camera 1000 stores a fixed angle-of-view area setting in the storage unit 1002.

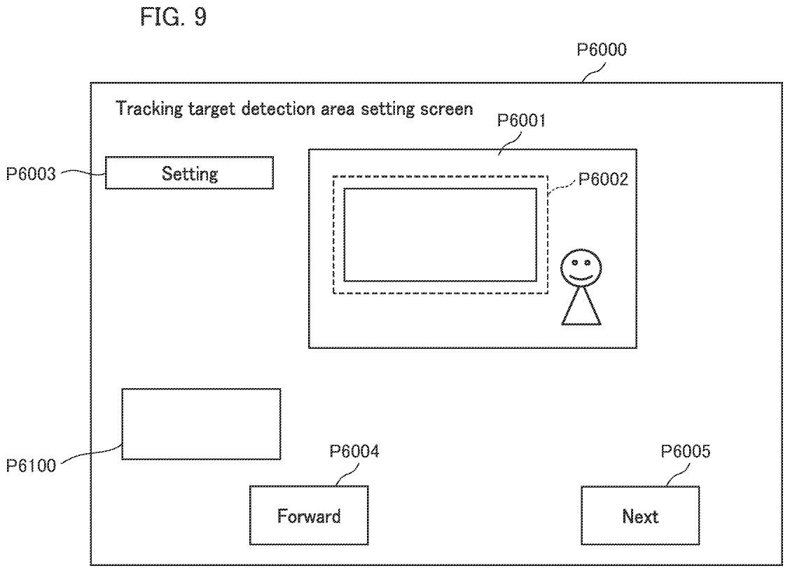

When the input unit 2004 is operated and the forward button P5007 is pressed, the screen transitions to the third setting screen P4000 illustrated in FIG. 7. On the other hand, when the input unit 2004 is operated and the next button P5008 is pressed, the screen transitions to a fifth setting screen P6000 illustrated in FIG. 9.

Next, the fifth setting screen P6000 will be described with reference to FIG. 9. FIG. 9 is a diagram illustrating the fifth setting screen P6000 of the client apparatus 2000 according to the first embodiment. The fifth setting screen P6000 is a setting screen (UI) for setting a tracking target detection area (second area). The tracking target detection area is an area for detecting a tracking target when tracking is started. The tracking target detection area is different from the tracking imaging area set on the setting screen illustrated in FIG. 5, but is an area related to a tracking operation (another tracking imaging area).

The fifth setting screen P6000 is displayed on the display unit 2003 of the client apparatus 2000 so that it can be operated and set. A video display area P6001, an information display area P6100, a tracking target detection area frame P6002, a setting button P6003, a forward button P6004, and a next button P6005 are displayed on the fifth setting screen P6000.

The video display area P6001 is a display area for displaying a video received from the network camera 1000. The information display area P6100 is a display area for displaying a tracking setting error or the like. It is preferable that the tracking setting error or the like displayed in the information display area P6100 on the fifth setting screen P6000 be a message based on the detected error. However, this is not limiting, and a predetermined icon corresponding to the error or the like may be displayed. The imaging area displayed in the video display area P6001 is an initial position area that is set through the second setting screen P3000 illustrated in FIG. 6.

Here, the user operates the input unit 2004 to designate the tracking target detection area frame P6002 on the video display area P6001. The tracking target detection area frame P6002 illustrated in FIG. 9 is an example, and the user can designate a frame having any size. Next, when the user operates the input unit 2004 and presses the setting button P6003, a tracking area setting command including information on the tracking target detection area is transmitted from the communication unit 2006 to the network camera 1000. After the communication unit 1005 receives the tracking area setting command from the client apparatus 2000, the network camera 1000 stores a tracking target detection area setting in the storage unit 1002.

When the forward button P6004 is pressed through the input unit 2004, the screen transitions to the fourth setting screen P5000 illustrated in FIG. 8. On the other hand, when the input unit 2004 is operated and the next button P6005 is pressed, the screen transitions to the tracking execution screen P1000 illustrated in FIG. 4.

Although the settings of a tracking imaging area and another tracking imaging area, the operations therefor, and the like have been described above with reference to FIGS. 4 to 9, the screens illustrated in FIGS. 4 to 9 are examples of preferred embodiments of the network camera and the client apparatus in the first embodiment, and this is not limiting. For example, various modifications and changes, such as changing the order of setting of a tracking imaging area, setting a plurality of tracking imaging areas on one screen, and subdividing them, can be made within the scope of the present invention.

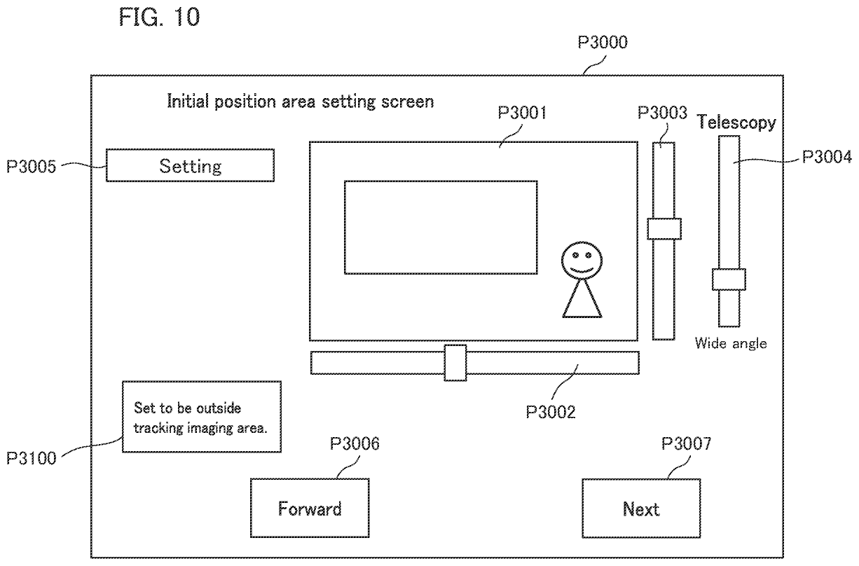

A notification that an initial position area of the network camera 1000 is outside a tracking imaging area and the display of the second setting screen P3000 of the client apparatus 2000 will be described below with reference to FIG. 10. FIG. 10 is a diagram illustrating a notification that an initial position area of the network camera 1000 is outside a tracking imaging area and the display of the second setting screen P3000 of the client apparatus 2000 according to the first embodiment. Since the contents other than the information display area P3100 illustrated in FIG. 10 are the same as those described with reference to FIG. 6, detailed description thereof will be omitted.

As described with reference to FIG. 3, the client apparatus 2000 transmits a tracking area information acquisition command to the network camera 1000 by using a tracking setting UI. Next, the network camera 1000 receives the command and then transmits tracking area information to the client apparatus 2000, and thus the client apparatus 2000 can acquire the tracking area information. Next, the client apparatus 2000 updates the display of the tracking setting UI with the contents of the received tracking area information.

Here, the control unit 1001 of the network camera 1000 performs processing for referring to information indicating the initial position area included in the tracking area information. After the processing, when the initial position area is outside a tracking imaging area range, the client apparatus 2000 is notified that the initial position area is outside the tracking imaging area (first notification). Specifically, a setting screen (tracking setting UI) including a message indicating that the tracking area other than the tracking imaging area is outside the tracking imaging area is transmitted.

As a notification at this time, the control unit 2001 of the client apparatus 2000 displays a predetermined warning message in the information display area P3100 on the second setting screen P3000 (on the setting screen). As the predetermined warning message, any wording may be used as long as it is a message to the effect that the initial position area is outside the tracking imaging area. On the other hand, when the initial position area is not outside the tracking imaging area, nothing is displayed in the information display area P3100. When the initial position area is not outside the tracking imaging area, for example, a message or the like to the effect that the initial position area is within the tracking area may be displayed. Further, when a message indicating that the initial position area is outside the tracking imaging area is displayed in the information display area P3100, the color of characters to be displayed may be changed or the characters may be highlighted.

Although giving a notification that the initial position area is outside the tracking imaging area on the second setting screen P3000 for setting the initial position area has been described here with reference to FIG. 10, the same notification and display as those on each setting screen for setting other tracking areas are performed. For example, in the third setting screen P4000 for setting the priority display area illustrated in FIG. 7, the priority display area being outside the tracking imaging area is displayed in the information display area P4100. Furthermore, in the fourth setting screen P5000 for setting the fixed angle-of-view area illustrated in FIG. 8, the fixed angle-of-view area being outside the tracking imaging area is displayed in an information display area P5100. Furthermore, in the fifth setting screen P6000 for setting the tracking target detection area illustrated in FIG. 9, the tracking target detection area being outside the tracking imaging area is displayed in the information display area P6100.

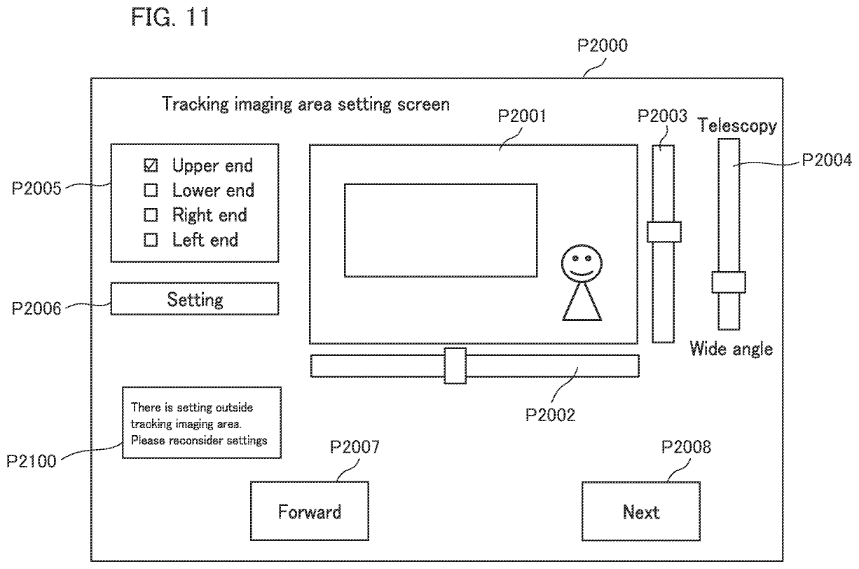

A notification that a tracking area other than a tracking imaging area of the network camera 1000 is outside a tracking imaging area and the display of the first setting screen P2000 of the client apparatus 2000 will be described below with reference to FIG. 11. FIG. 11 is a diagram illustrating a notification that a tracking area other than a tracking imaging area of the network camera 1000 according to the first embodiment is outside a tracking imaging area, and the display of the first setting screen P2000 of the client apparatus 2000. More specifically, FIG. 11 illustrates the display of the first setting screen P2000 when the forward button P3006 is pressed while a message to the effect that an initial position area is outside a tracking imaging area is displayed on the second setting screen P3000 in FIG. 10. In other words, this is the display when the user does not change the initial position area even though the message as illustrated in FIG. 10 is displayed. A message indicating that a tracking area other than a tracking imaging area is outside the tracking imaging area is also displayed on the first setting screen P2000, which is not a setting screen for an initial position area, and thus the user is prompted to move to the second setting screen P3000 and reconsider the settings. Since the contents other than the information display area P2100 in FIG. 11 are the same as those described in FIG. 5, detailed description will be omitted.

As described with reference to FIG. 3, the client apparatus 2000 transmits a tracking area information acquisition command to the network camera 1000 using the tracking setting UI. Next, after the network camera 1000 receives the command, the network camera 1000 transmits tracking area information (information on a tracking imaging area) to the client apparatus 2000, and thus the client apparatus 2000 can acquire the tracking area information. Next, the client apparatus 2000 updates the display of the tracking setting UI with the contents of the received tracking area information.

Here, the control unit 1001 of the network camera 1000 performs processing for referring to information indicating whether the tracking area other than the tracking imaging area included in the tracking area information is outside a tracking imaging area range. After the processing is performed, when the tracking area other than the tracking imaging area is outside the tracking imaging area range, the client apparatus 2000 is notified that the tracking area other than the tracking imaging area is outside the tracking imaging area (first notification). Specifically, a setting screen (tracking setting UI) including a message to the effect that the tracking area other than the tracking imaging area is outside the tracking imaging area is transmitted.

As a notification at this time, the control unit 2001 of the client apparatus 2000 displays a predetermined warning message in the information display area P2100 on the first setting screen P2000 (on the setting screen). As the predetermined warning message, any wording may be used as long as it is a message to the effect that the tracking area other than the tracking imaging area is outside the tracking imaging area. On the other hand, when the tracking area is not outside the tracking imaging area, nothing is displayed in the information display area P2100. When the tracking area is not outside the tracking imaging area, for example, a message or the like to the effect that it is within the tracking area may be displayed. Further, when a message indicating that the initial position area is outside the tracking imaging area is displayed in the information display area P2100, the color of characters to be displayed may be changed or the characters may be highlighted.

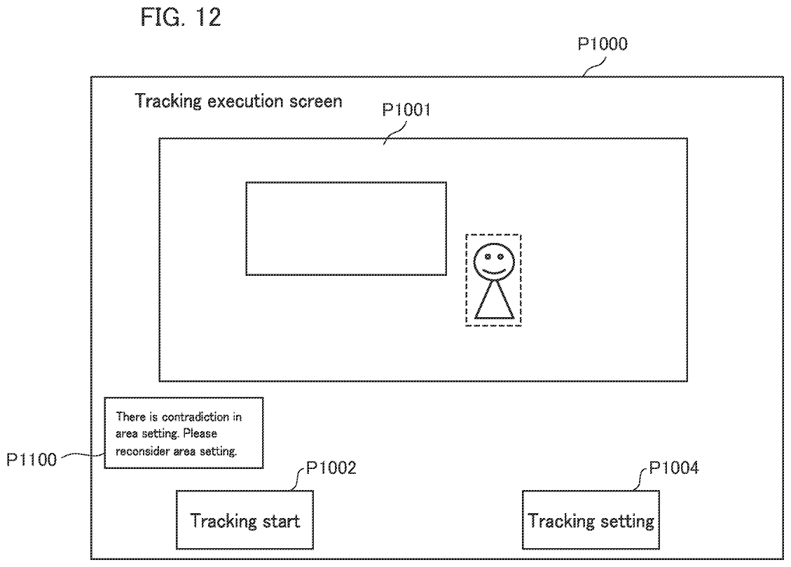

A notification that the tracking area other than the tracking imaging area of the network camera 1000 is outside the tracking imaging area and the display of the tracking execution screen P1000 of the client apparatus 2000 will be described below with reference to FIG. 12. FIG. 12 is a diagram illustrating a notification that a tracking area other than a tracking imaging area of the network camera 1000 according to the first embodiment is outside a tracking imaging area and the display of the tracking execution screen P1000 of the client apparatus 2000. More specifically, FIG. 12 illustrates a display when the screen returns to the tracking execution screen P1000 while a message to the effect that a setting area is outside a tracking imaging area is displayed on at least one setting screen. The at least one setting screen mentioned above is the second setting screen P3000, the third setting screen P4000, the fourth setting screen P5000, or the fifth setting screen P6000. Since the contents other than the information display area P1100 and the tracking start button P1002 in FIG. 12 are the same as those described in FIG. 4, detailed description will be omitted.

As described with reference to FIG. 3, the client apparatus 2000 transmits a tracking area information acquisition command to the network camera 1000 using a tracking setting UI. Next, after the network camera 1000 receives the command, the network camera 1000 transmits tracking area information (information on a tracking imaging area) to the client apparatus 2000, and thus the client apparatus 2000 can acquire the tracking area information. Next, the client apparatus 2000 updates the display of the tracking setting UI with the contents of the received tracking area information.

Here, the control unit 1001 of the network camera 1000 performs processing for referring to information indicating whether a tracking area other than the tracking imaging area included in the tracking area information is outside a tracking imaging area range. After the processing is performed, when the tracking area other than the tracking imaging area is outside the tracking imaging area range, the client apparatus 2000 is notified that the tracking area other than the tracking imaging area is outside the tracking imaging area and that there is a contradiction between tracking area settings (first notification). Specifically, a setting screen (tracking setting UI) including a message to the effect that the tracking area other than the tracking imaging area is outside the tracking imaging area and there is a contradiction between the tracking area settings is transmitted. In addition, the operation of the tracking start button P1002 is invalidated so as not to start tracking. Specifically, the client apparatus 2000 grays out the tracking start button P1002 when receiving a notification that the tracking area other than the tracking imaging area is outside the tracking imaging area and that there is a contradiction between the tracking area settings. Thereby, it is indicated to the user that the operation of the tracking start button P1002 is invalid. Alternatively, the network camera 100 discards the tracking start command received from the client apparatus 2000 so as not to start tracking.

As a notification at this time, the control unit 2001 of the client apparatus 2000 displays a predetermined warning message in the information display area P1100 on the tracking execution screen P1000 (on the setting screen). As the predetermined warning message, any wording may be used as long as it is a message to the effect that the tracking area other than the tracking imaging area is outside the tracking imaging area and there is a contradiction between the tracking area settings. On the other hand, when the tracking area is not outside the tracking imaging area, nothing is displayed in the information display area P1100. When the tracking area is not outside the tracking imaging area, for example, a message or the like to the effect that it is within the tracking area may be displayed. Further, when a message indicating that the initial position area is outside the tracking imaging area is displayed in the information display area P1100, the color of characters to be displayed may be changed or the characters may be highlighted.

As described above, in the first embodiment, the user is notified that a tracking area other than the tracking imaging area (another tracking imaging area) is outside a tracking imaging area, and an operation of starting tracking is invalidated, thereby making it possible to prevent inconsistency between a tracking area set by the user and a tracking operation.

In addition, a combination of symbols, figures, images, and the like may be displayed in a message to be displayed on each setting screen. For example, if only a position in the right direction in the drawing is outside a tracking imaging area in a set area, a message to that effect and an arrow pointing to the left may be displayed, and correction of the position in the right direction may be indicated to the user. In addition, it is not limited to suggesting a direction that is outside the tracking imaging area, but a message such as “Please reduce a setting range by a few percent”, a specific message indicating what is outside the tracking imaging area, a message that embodies a correction point, or the like may be displayed. Thereby, the user can easily confirm which portion of the set area is outside the tracking imaging area. Furthermore, it is possible to easily grasp a portion to be corrected.

### Second Embodiment

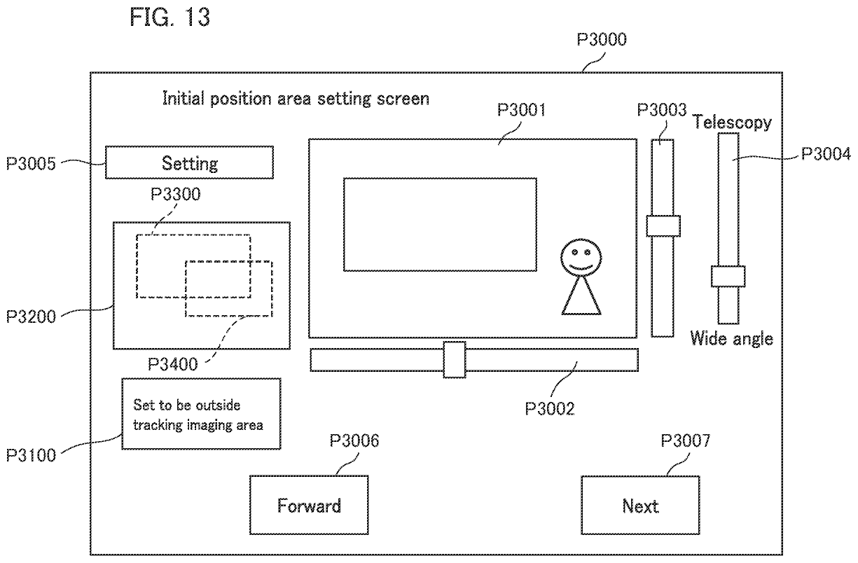

A notification that an initial position area of a network camera 1000 according to a second embodiment is outside a tracking imaging area and the display of a second setting screen P3000 of a client apparatus 2000 will be described below with reference to FIG. 13. In the second embodiment, functional configurations and each processing of the network camera 1000 and the client apparatus 2000 are the same as those in the first embodiment, and thus description thereof will be omitted. In the second embodiment, differences from the first embodiment will be described, and descriptions of the same parts (including FIGS. 1 to 12) as in the first embodiment will be omitted.

FIG. 13 is a diagram illustrating a notification that an initial position area of the network camera 1000 is outside a tracking imaging area and the display of the second setting screen P3000 of the client apparatus 2000 according to the second embodiment. In FIG. 13, a display area P3200, a tracking imaging area P3300, and an initial position area P3400 are added to the configuration of FIG. 10. A control unit 1001 of the network camera 1000 in the second embodiment transmits a setting screen (tracking setting UI) including a screen including a movable range of an imaging unit 1003, a tracking imaging area, and a tracking area other than the tracking imaging area.

In the display area P3200, a PTZ movable range of the network camera 1000 is displayed graphically. In the tracking imaging area P3300, a tracking imaging area in the PTZ movable range is displayed. An initial position area within the PTZ movable range is displayed in the initial position area P3400. By displaying the display area P3200, the tracking imaging area P3300, and the initial position area P3400 in the PTZ movable range, the user can easily confirm whether the initial position area is outside the tracking imaging area. In the second embodiment, a tracking imaging area P3300 and the initial position area P3400 in the PTZ movable range are displayed in a display area in the PTZ movable range.

Although the display of the second setting screen P3000 has been described in FIG. 13, the display area P3200, the tracking imaging area P3300, and the initial position area P3400 are also added and displayed in the same manner on each setting screen for setting other tracking areas. For example, in the third setting screen P4000 for setting the priority display area illustrated in FIG. 7, the same display as in FIG. 13 is performed with P3400 as a priority display area. Further, in the fourth setting screen P5000 for setting a fixed angle-of-view area illustrated in FIG. 8, the same display as in FIG. 13 is performed with P3400 as a fixed angle-of-view area. Furthermore, in the fifth setting screen P6000 for setting a tracking target detection area illustrated in FIG. 9, the same display as in FIG. 13 is performed with P3400 as a tracking target detection area. Thereby, the user can confirm whether each tracking area is outside a tracking imaging area no matter which setting screen the user views.

Also in the second embodiment, similarly to the first embodiment, the control unit 1001 of the network camera 1000 performs, on the client apparatus 2000, each notification and processing for invalidating the operation of a tracking start button P1002 so as not to start tracking as in the first embodiment.

Similarly to the first embodiment, a combination of symbols, figures, images, and the like may be displayed in a message to be displayed on each setting screen. In the second embodiment, for example, a specific message indicating whether a PTZ movable range is outside a tracking imaging area or a message that embodies a correction point may be displayed.

As described above, in the second embodiment, the user is notified that a tracking area other than a tracking imaging area is outside the tracking imaging area, together with a drawing of a PTZ movable range displayed on each setting screen, and inconsistency between a tracking area set by the user and a tracking operation can be prevented by invalidating an operation of starting tracking.

### Third Embodiment

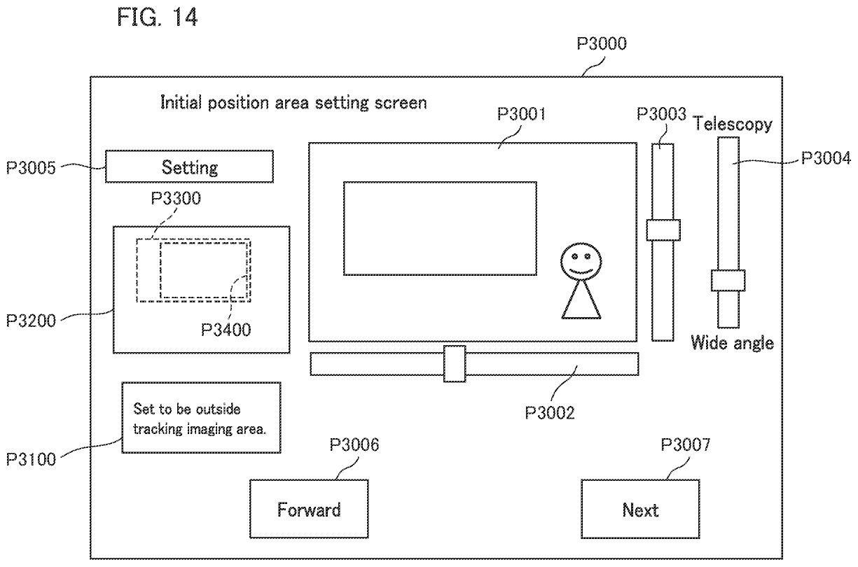

A notification that an initial position area of a network camera 1000 according to a third embodiment is outside a tracking imaging area and the display of a second setting screen P3000 of a client apparatus 2000 will be described below with reference to FIG. 14. In the third embodiment, functional configurations and each processing of the network camera 1000 and the client apparatus 2000 are the same as those in the first embodiment, and thus description thereof will be omitted. In the third embodiment, differences from first embodiment and the second embodiment will be described, and descriptions of the same parts (including FIGS. 1 to 13) as in the first embodiment and the second embodiment will be omitted.

FIG. 14 is a diagram illustrating a notification that an initial position area of the network camera 1000 is outside a tracking imaging area and the display of the second setting screen P3000 of the client apparatus 2000 according to the third embodiment. Since FIG. 14 is the same as FIG. 13 except for the points described below, redundant description will be omitted.

In the third embodiment, when the user operates an input unit 2004 and presses a setting button P3005, a tracking area setting command is transmitted to the network camera 1000. When an initial position area included in the tracking area setting command transmitted at that time is outside a tracking area range, a control unit 1001 performs processing (correction processing) for making the initial position area fall within the tracking area range and stores it as an initial position area setting of a storage unit 1002. The control unit 1001 notifies the client apparatus 2000 that the initial position area is within the tracking area range (second notification). Specifically, a setting screen (tracking setting UI) including a message to the effect that a tracking area other than the tracking imaging area falls within the tracking area range is transmitted.

As a notification at this time, a predetermined message is displayed in an information display area P3100 on the second setting screen P3000. As the predetermined message, any wording may be used as long as it is a message to the effect that the initial position area falls within the tracking area range.

Although the display and operation of an initial position area setting screen have been described with reference to FIG. 14, a display area P3200, a tracking imaging area P3300, and an initial position area P3400 are added to each setting screen for setting other tracking areas, and the same display is performed. For example, in the third setting screen P4000 for setting the priority display area illustrated in FIG. 7, the same processing as in FIG. 14 is performed to perform a display with P3400 as a priority display area. Furthermore, in the fourth setting screen P5000 for setting the fixed angle-of-view area illustrated in FIG. 8, the same processing as in FIG. 14 is performed to perform a display with P3400 as a fixed angle-of-view area. Furthermore, in the fifth setting screen P6000 for setting the tracking target detection area illustrated in FIG. 9, the same processing as in FIG. 14 is performed to perform a display with P3400 as a tracking target detection area. Thereby, the user can confirm that each tracking area falls within a tracking imaging area no matter which setting screen the user views.

Also in the third embodiment, similarly to the first embodiment, the control unit 1001 of the network camera 1000 performs, on the client apparatus 2000, each notification and processing for invalidating the operation of a tracking start button P1002 in the client apparatus 2000 so as not to start tracking as in the first embodiment. Each processing at this time may be performed by a control unit 2001 of the client apparatus 2000.

Similarly to the first embodiment, a combination of symbols, figures, images, and the like may be displayed in a message to be displayed on each setting screen. In the third embodiment, for example, a specific message or the like, such as how a set area has been corrected, may be displayed.

As described above, in the third embodiment, the user is notified that a tracking area other than a tracking imaging area falls within the tracking imaging area, together with a drawing of a PTZ movable range, and thus it is possible to prevent inconsistency between a tracking area set by the user and a tracking operation.

Although the preferred embodiments of the present invention have been described above, the present invention is not limited to these embodiments, and various modifications and changes can be made within the scope of the gist. In addition, although a plurality of embodiments have been described above in detail, the present invention can be embodied as, for example, systems, devices, methods, programs, recording media (storage media), and the like. Specifically, the present invention may be applied to a system constituted by a plurality of pieces of equipment (for example, a host computer, an interface device, an image capturing apparatus, a WEB application, and the like), or may be applied to a device constituted by single equipment. For example, some of the functional units of the network camera 100 illustrated in FIG. 2(A) may be included in a server, a storage device, or the like different from the network camera 1000 to communicate with the network camera 100 based on wired connection or wireless connection, thereby realizing the functions of the embodiments. The client apparatus 2000 may have an imaging function. In this case, for example, the client apparatus 2000 can be configured to include an imaging unit 1003 and an imaging control unit 1006.

The present invention can also be implemented through processing for supplying a program that implements one or more functions of the above-described embodiments to a system or a device via a network or a storage medium, and causing one or more processors in a computer of the system or the device to read and execute the program. In this case, the program and a storage medium storing the program constitute the present invention. The present invention can also be implemented by a circuit (for example, ASIC) that implements one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-182177, Nov. 14, 2022, which is hereby incorporated by reference wherein in its entirety.

What is claimed is:

1. An image capturing apparatus comprising:
one or more memories storing instructions; and
one or more processors executing the instructions to
image a tracking target,
receive information of a first area, which is an area for tracking the tracking target, and information of a second area different from the first area, from a client apparatus, and
notify the client apparatus of information indicating whether the second area is outside a range of the first area as a first notification.

2. The image capturing apparatus according to claim 1,
wherein the one or more processors transmit a user interface (UI) including a predetermined message on a setting screen for inputting the second area to the client apparatus as the first notification.

3. The image capturing apparatus according to claim 2,
wherein the one or more processors transmit a user interface (UI) including a message to an effect that the second area is outside a range of the first area on a setting screen for inputting the first area to the client apparatus as the first notification.

4. The image capturing apparatus according to claim 1,
wherein the one or more processors transmit, as the first notification, a user interface (UI) including a message to an effect that the second area is outside a range of the first area on a screen where it is able to perform selection between start of tracking and transition to a setting screen for inputting the first area to the client apparatus.

5. The image capturing apparatus according to claim 4,
wherein the one or more processors invalidate execution of processing for starting tracking when a user interface (UI) including a message to the effect that the second area is outside a range of the first area on the screen is transmitted.

6. The image capturing apparatus according to claim 1,
wherein the second area is an initial position area, and
the initial position area is an area to which an imaging unit that images a tracking target moves when the tracking target is lost during tracking.

7. The image capturing apparatus according to claim 1,
wherein the second area is a fixed angle-of-view area, and
the fixed angle-of-view area is an area where the fixed angle-of-view area is used as an imaging area when the tracking target enters the fixed angle-of-view area.

8. The image capturing apparatus according to claim 1,
wherein the second area is a tracking target detection area, and
the tracking target detection area is an area where the tracking target is detected when tracking is started.

9. The image capturing apparatus according to claim 3,
wherein the one or more processors transmit a user interface (UI) including the setting screen for inputting the first area and the setting screen for inputting the second area to the client apparatus.

10. The image capturing apparatus according to claim 1,
wherein the one or more processors transmit a user interface (UI) including a screen including a movable range of the imaging unit, the first area, and the second area on a setting screen for inputting the second area to the client apparatus.

11. The image capturing apparatus according to claim 1,
wherein the one or more processors correct the second area to be within a range of the first area when the second area is outside a range of the first area, and notify the client apparatus that the second area has been corrected as a second notification.

12. The image capturing apparatus according to claim 11,
wherein the one or more processors transmit a user interface (UI) including a predetermined message on a setting screen for inputting the second area to the client apparatus as the second notification.

13. The image capturing apparatus according to claim 1,
wherein the one or more processors control the imaging unit to track the tracking target based on a predetermined control signal transmitted from the client apparatus.

14. A control method of an image capturing apparatus, the control method comprising:
imaging a tracking target;
receiving information of a first area, which is an area for tracking the tracking target, and information of a second area different from the first area, from a client apparatus; and
notifying the client apparatus of information indicating whether the second area is outside a range of the first area as a first notification.

15. A non-transitory computer-readable storage medium configured to store a computer program comprising instructions for executing following processes:
imaging a tracking target;
receiving information of a first area, which is an area for tracking the tracking target, and information of a second area different from the first area, from a client apparatus; and
notifying the client apparatus of information indicating whether the second area is outside a range of the first area as a first notification.
